(19) United States
(12) Patent Application Publication
(10) Pub. No.: US 2005/0097106 A1
(43) Pub. Date: May 5, 2005

(54) Methods, systems and computer program products for multi-protocol self-service application access

(76) Inventor: David J. Lineman, Houston, TX (US)

Correspondence Address: Robert W. Glatz;Myers Bigel Sibley & Sajovec, P.A., P.O. Box 37428, Raleigh, NC, 27627, US

(21) Appl. No.: 10/696,098

(22) Filed: Oct. 29, 2003

(51) Int. Cl. G06F 7/00

(52) U.S. Cl. 707/10

(57) ABSTRACT

Methods, systems and computer program products for multi-protocol self-service application access receive a user access request from a user at a server associated with the self-service application. It is determined whether a protocol of the received request is a wireless or wired protocol. The received request is formatted to a common format for processing by the self-service application. A responsive query is selectively transmitted from the self-service application to the user based on the wireless protocol when the received request is a wireless protocol request and based on the wired protocol when the received request is a wired protocol request based on whether the received request is determined to be a wireless or wired protocol. The self-service application may be, for example, a network password and/or account privileges management application and the responsive query may be, for example, a challenge question to validate the user access request.

### BACKGROUND OF THE INVENTION

The present invention, generally, relates to self-service applications and, more particularly, to methods, systems and computer program products for accessing self-service applications.

Responding to user requests related to a service provided to a large group of users, such as authorized users of a computer network, may become a significant expense for the service provider to manage user accounts. For example, it is believed that about thirty percent of calls to a corporate network support department (or help desk of an Internet service provider) are from users who have forgotten their password and are unable to log onto the network. Industry analysts have estimated that the average cost of a help desk call is $25US per call. As the network environment becomes more secure (i.e., stronger password policies), more service calls may be generated. Therefore, a built-in resistance may result to enforcing strong password policies even though such stronger policies may provide a much more secure network environment.

As a result of the often high service costs for such environments, a variety of software products have been introduced to allow users to manage their own accounts, for example, their own passwords. Typically, these products are web-based applications that run on a corporate intranet and allow users to reset their password by going, for example, to a “kiosk” and answering a series of challenge questions. The challenge questions are generally setup by an administrator and each user is required to configure his or her profile by answering the challenge questions, such as their mother's maiden name, their favorite color, their favorite brand of cereal or the like. Such a solution may be as secure as the typical network administrator operated username and password management. Once authenticated, the user may be allowed, for example, to reset their password, enable an account that was locked out or the like. Some known self-service applications even allow synchronization of the user's password across multiple systems.

While these known systems may work well for users on the local network, many organizations have large numbers of remote users who do not have access to the network, for example, if they have forgotten their password. One known approach to addressing this situation is Interactive Voice Response (IVR) as illustrated in FIG. 1. As illustrated in FIG. 1, a local user 100 may access the self-service software application server 105 directly over the wired computer network infrastructure using, for example, the Hyper-Text Transfer Protocol (HTTP). A remote user 110, using a conventional or wireless phone, accesses an IVR Server/Telephony system 115 over the public switched telephone network (PSTN) 112. The IVR server 115 may then translate the communications to text and provide them to the self-service software application server 105 using, for example, an eXtensible Mark-up Language (XML) translator 117.

Using IVR technology, a user can call a specific number and answer questions via telephone for authentication. IVR systems generally allow a caller to navigate through menus using voice recognition and/or tone signals from the phone keypad. Examples of such systems include those used for refilling prescriptions and checking account balances.

A variety of approaches to integration of IVR with password-reset tools are known. The options range from turnkey systems that are installed within the corporate information technology (IT) environment to outsourced services that host the entire IVR system remotely. In any case, the corporation typically incurs additional hardware and integration costs, either directly of through a subscription payment to the IVR service provider. The IVR approach may not only be more expensive, but may also require some form of custom development within the self-service software application and/or IVR application. As a result, a more complicated and costly setup may be required and the resulting system may be costly to maintain.

### SUMMARY OF THE INVENTION

Embodiments of the present invention provide multi-protocol self-service application access including receiving a user access request from a user at a server associated with the self-service application. It is determined whether a protocol of the received request is a wireless or wired protocol. The received request is formatted to a common format for processing by the self-service application. A responsive query is selectively transmitted from the self-service application to the user based on the wireless protocol when the received request is a wireless protocol request and based on the wired protocol when the received request is a wired protocol request based on whether the received request is determined to be a wireless or wired protocol. The self-service application may be, for example, a network password and/or account privileges management application and the responsive query may be, for example, a challenge question to validate the user access request.

In further embodiments of the present invention, transmitting a responsive query includes formatting the responsive query based on the wireless protocol when the received request is a wireless protocol request and based on the wired protocol when the received request is a wired protocol request and transmitting the formatted responsive query. The wireless protocol may be a wireless access protocol (WAP) and the wired protocol may be a Hypertext Transfer Protocol (HTTP). The wireless access protocol may use wireless mark-up language (WML) and the wired protocol may use hypertext mark-up language (HTML).

In other embodiments of the present invention, the common format is a data format of the self-service application and formatting the responsive query includes receiving the responsive query from the self-service application in the data format of the self-service application. The formatted responsive query may be a text query and the user access request may also be a text query. The user access request may include a user identifier and the responsive query may be a challenge question(s) selected based on the user identifier to validate the user access request.

In further embodiments of the present invention, the access system receives a response to the challenge question from the user at the server associated with the self-service application. It is determined whether the received response to the challenge question is a wireless or wired protocol request. The received response to the challenge question is formatted to the common format for processing by the self-service application. A confirmation of execution of the received self-service request is transmitted to the user if the user access request is validated.

In other embodiments of the present invention, the self-service application receives the user access request in the common format and selects the responsive query based on the user identifier. The self-service application further receives the received response to the challenge question in the common format and determines if the user access request is valid based on the received response to the challenge question. The user access request is serviced only if the user access request is valid.

In further embodiments of the present invention, multi-protocol self-service application access systems are provided including a wireless protocol communication interface configured to receive a user access request from a user and transmit a responsive query to a user using a wireless protocol and a wired protocol communication interface configured to receive a user access request from a user and transmit a responsive query to a user using a wired protocol. The access system further includes a conversion circuit configure to format the received user access requests to a common format for processing by the self-service application. The conversion circuit may also be configured to format the responsive query based on the wireless protocol when the received request is a wireless protocol request and based on the wired protocol when the received request is a wired protocol request and to receive the responsive query from the self-service application in the data format of the self-service application.

In other embodiments of the present invention, the conversion circuit is configured to format a received response to the challenge question in the wireless protocol or the wired protocol to the common format for processing by the self-service application. The system further includes a validation circuit that determines if the user access request is valid based on the formatted received response to the challenge question. The system may further include a service circuit that services the user access request only if the user access request is valid. The validation circuit and the service circuit may be the self-service application.

While described above primarily with reference to methods, systems and computer program products are also provided in accordance with further embodiments of the present invention.

### BRIEF DESCRIPTION OF THE DRAWINGS

FIG. 1 is a schematic diagram of a self-service application access system using IVR and telephony;

FIG. 2 is a block diagram of a hardware and software environment in which the present invention may operate according to some embodiments of the present invention;

FIG. 3 is a block diagram of multi-protocol self-service application system according to some embodiments of the present invention;

FIG. 4 is a flowchart illustrating operations for a multi-protocol accessing of a self-service application according to some embodiments of the present invention;

FIG. 5 is a flowchart illustrating operations for a multi-protocol accessing of a self-service application according to some embodiments of the present invention;

FIG. 6 is a flowchart illustrating operations for a multi-protocol accessing of a self-service application according to some embodiments of the present invention;

FIG. 7 is a flowchart illustrating operations for a multi-protocol accessing of a self-service application according to some embodiments of the present invention;

FIG. 8 is a flowchart illustrating operations for a multi-protocol accessing of a password maintenance application according to some embodiments of the present invention; and

FIGS. 9A and 9B are schematic block diagrams illustrating mock-up screens of a wireless terminal for displays to a user providing a user access request and responses to query challenge questions according to some embodiments of the present invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable locally or remotely computer readable medium may be used including hard disks, CD-ROMs, optical storage devices, a transmission media such as those supporting the Internet or an intranet, or magnetic storage devices.

Computer program code for carrying out operations of the present invention may be written in an object oriented programming language, such as Java® or C++ or C#. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN).

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer- or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

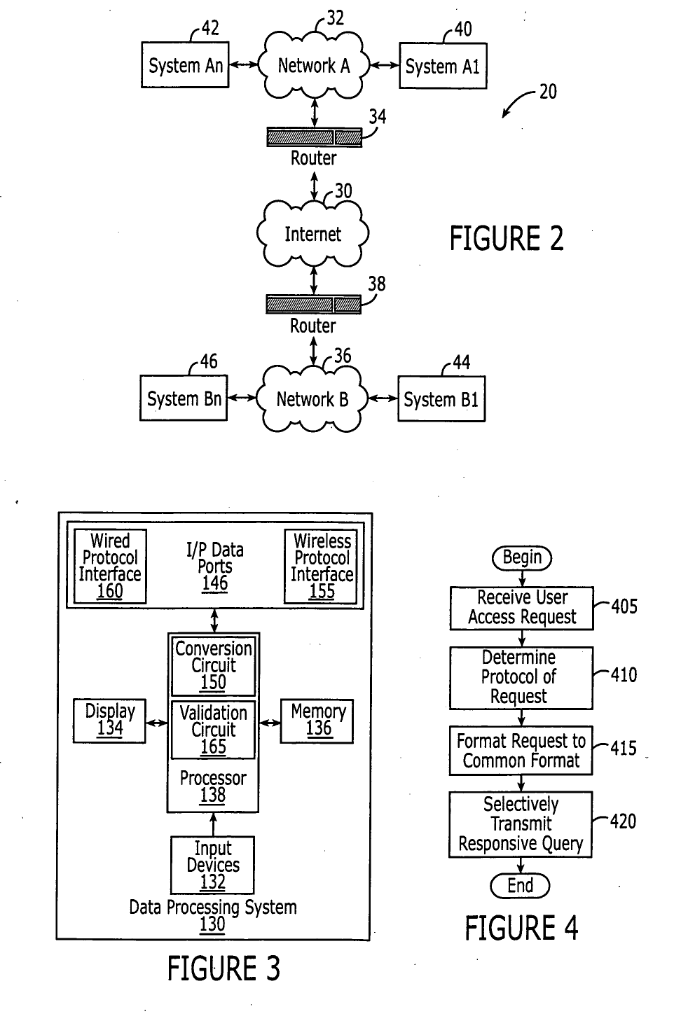

Embodiments of the present invention will now be described with respect to the figures. Embodiments of the present invention provide methods, systems and/or computer program products for multi-protocol access to self-service applications. Referring first to FIG. 2, a hardware and software environment in which the present invention can operate will be described. The network 20 provides a communication link between a series of data processing (computer) systems 40, 42, 44, 46 that may operate as clients and/or servers configured to generate and or display data in accordance with embodiments of the present invention.

As will be understood by those having skill in the art, a network 20 may include a plurality of separate linked physical communication networks, which, using a protocol such as the Internet protocol (IP), may appear to be a single seamless communications network to user application programs. For example, as illustrated in FIG. 2, the network 32 and the network 36 may be local networks or intranets coupled to each other over the Internet network 30 via the respective routers 34, 38. It is further to be understood that, while for illustration purposes in FIG. 2 the communication networks 30, 32, 36 are each shown as a single network, they may be comprised of a plurality of separate interconnected physical networks.

Applications may execute on various devices 40, 42, 44, 46 using the network 20, for example, using a client/server model. In the context of World Wide Web client/server applications, the client may be a web browser that acts as the user interface. The web browser sends user requests to the appropriate web server using the Hyper-Text Markup Language (HTML) protocols and formats and display the HTML data returned from the web server (although formatting may occur at the server). The web browser may also evaluate the HTML data to determine if there are any embedded hyper-link statements in the HTML data that would require subsequent browser requests to be initiated by the browser. A web server acts as the server for the client and processes the web browser's requests and returns the requested response as an HTML data portion of a Hyper-Text Transfer Protocol (HTTP) data stream.

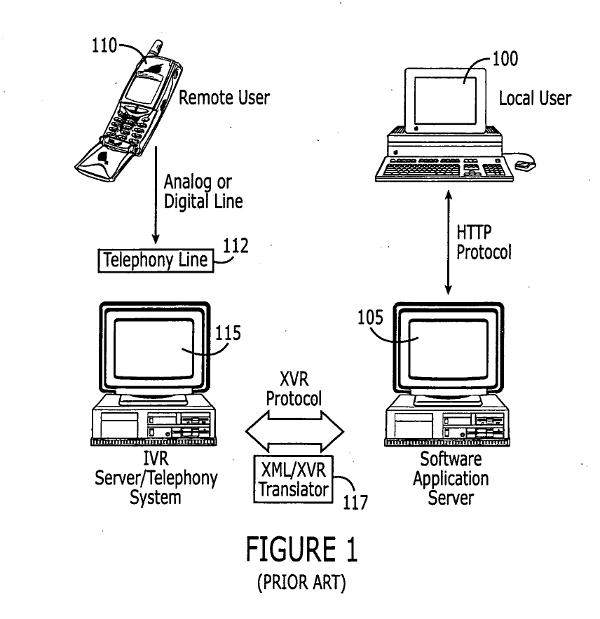

FIG. 3 illustrates an exemplary embodiment of a data processing system suitable for use as a multi-protocol self-service application access system 130 in accordance with embodiments of the present invention. The access system 130 typically includes input device(s) 132 such as a keyboard or keypad, a display 134 and a memory 136 that communicate with a processor 138. The access system 130 may further include an I/O data port(s) 146 that also communicate with the processor 138. The I/O data ports 146 can be used to transfer information between the data processing system 130 and another computer system or a network, such as the network 20 of FIG. 1. These components may be conventional components, such as those used in many conventional data processing systems, which may be configured to operate as described herein.

As shown in the embodiments of a multi-protocol self-service application access system 130 illustrated in FIG. 3, the I/O data ports 146 include a wireless protocol communication interface 155 and a wired protocol communication interface 160. The wireless protocol communication interface 155 is configured to receive and transmit communications to a user of the access system 130 using a wireless protocol. For example, the wireless protocol may be the Wireless Access Protocol (WAP) and the protocol may use the Wireless Marked-up Language (WML). Communications received from a user of the access system 130 may include a user access request for submission to the self-service application through the access system 130. The wired protocol communication interface 160 is configured to receive and transmit communications to a user using a wired protocol. For example, the wired protocol may be the Hypertext Transfer Protocol (HTTP) and may use the Hypertext Mark-up Language (HTML).

As also shown in the embodiments of FIG. 3, the processor 138 includes a conversion circuit 150 and a validation circuit 165. The conversion circuit 150 is configured to format received user access requests or other communications to a common format for processing by the self-service application associated with the access system 130. For example, the common format may be a data format of the self-service application. Thus, the conversion circuit 150 is configured to format received user access requests from both the wired protocol interface 160 and the wireless protocol interface 155 to a common format for processing by the self-service application.

For the embodiments illustrated in FIG. 3, the validation circuit 165 is provided in the processor 138 of the system 130 and is configured to determine if a user access request is valid based on received responses from the user to challenge questions transmitted by the system 130 responsive to the self-service application. However, it is to be understood that the validation circuit 165 may, instead, be included in the self-service application itself rather than in the access system 130.

While generally described with reference to processing of user access requests, the access system 130 is configured to provide conversion between a common format of the self-service application and either the wired protocol or wireless protocol for a variety of communications between a user and the self-service application. For example, conversion circuit 150 may be configured to format responsive queries using the wireless protocol or the wired protocol of a user as determined based on the format in which the original user access request is received at the system 130. In various embodiments of the present invention, the user access request and the responsive queries comprise text as contrasted with voice communications.

Furthermore, while the I/O data ports 146 and processor 138 each are illustrated in FIG. 3 in a single data processing system, as will be appreciated by those of skill in the art, such functionality may be distributed across one or more data processing systems. For example, the functionality of the validation circuit 165 may be provided on one or more data processing (computer) systems that are separate from the data processing system that provides other functionality of the multi-protocol self-service application system. Thus, the present invention should not be construed as limited to the configuration illustrated in FIG. 3 but may be provided by other arrangements and/or division of function between data processing systems.

The multi-protocol self-service application access system 130 according to various embodiments of the present invention addresses providing services to remote users of a self-service application utilizing wireless terminals, such as mobile phones, configured to access the self-service application. Mobile phone devices currently are generally configured to provide wireless internet access using a wireless protocol, such as WAP. Furthermore, cellular service providers typically support such a service and include it in calling plans as part of the plans themselves or as an additional charge item that can be added to the plans.

WAP applications may be developed for the mobile phones that serve content to both traditional browser applications and to mobile phones acting as wireless access devices. Typically, support for such an interface on the mobile phone is provided by a built-in browser that supports at least a limited set of internet access commands for use in client-server communications.

As noted above, the wireless mark-up language (WML) is a protocol that may be used by application developers to provide web pages that are accessed consistently by both wired and wireless devices. In accordance with various embodiments of the present invention, the use of IVR and the need for IVR integration to support remote users accessing a self-service application may thereby be avoided. For example, for a self-service application related to password management, the access system 130, in various embodiments, may permit a user to reset their password by typing information on a mobile phone or wireless personal digital assistant keypad without requiring a phone call to an IVR system. In addition to network password management, other self-service applications suitable for use with the access system 130 of the present invention may include account privileges management applications or the like providing self-service capabilities to remote clients using wireless terminals, such as mobile phones, personal digital assistants and the like supporting a wireless protocol such as WAP. The self-service access system 130 may include or be separate from and coupled to the self-service application itself. Access system 130 may provide data communication in either HTML or WML format so as to support both remote and local access to the self-service application in a common format of the self-service application in various embodiments of the present invention.

Embodiments of the present invention will now be described with reference to the flow chart illustration of FIG. 4. As shown in FIG. 4, operations relating to a multi-protocol self-service application access method begin at Block 405 when a user access request is received from a user at a server associated with the self-service application, such as the access system 130. It will be understood that the self-service application itself may be executed on the same server as the access application but need not be on the same server and the access application may execute on a distinct server dedicated to supporting multi-protocol self-service application access to both remote and local users.

It is determined whether a protocol of the received request is a wireless or a wired protocol (Block 410). The received request is formatted to a common format for processing by the self-service application whether received formatted as a wireless or wired protocol (Block 415). Once the received request is processed by the self-service application to designate an appropriate responsive query or queries for validating the users access, a responsive query or queries is selectively transmitted from the self-service application to the user (Block 420). The responsive query is transmitted based on the wireless protocol when the received request is a wireless protocol request and based on the wired protocol when the received request is a wired protocol request as determined at Block 410.

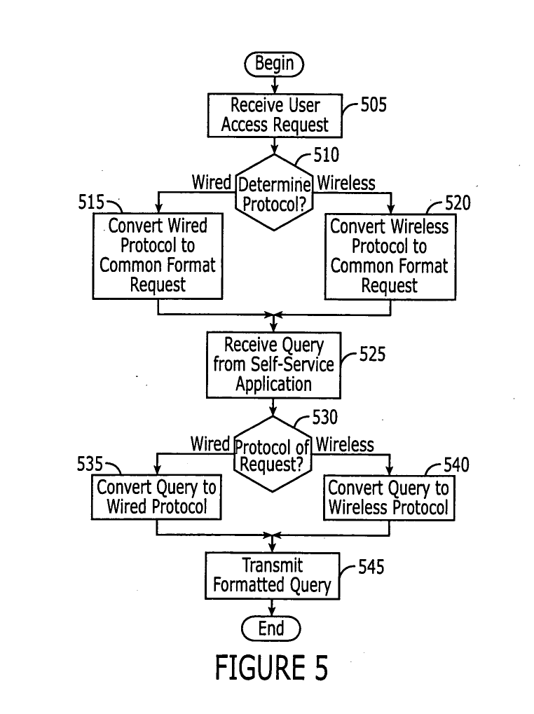

Further embodiments of methods for multi-protocol access to a self-service application according to the present invention will now be described with reference to the flow chart illustration of FIG. 5. As shown in FIG. 5, operations begin when a user access request is received (Block 505). A protocol of the received request is determined (Block 510). If the received request is a wired protocol request (Block 510), the request is converted from the wired protocol to a common format of the self-service application (Block 515). If the received request is a wireless protocol request (Block 510), the request is converted from the wireless protocol to the common format (Block 520). After the converted request is provided to the self-service application, a responsive query is received from the self-service application in the common format of the self-service application (Block 525). If the protocol of the associated user access request is a wired protocol (Block 530), the responsive query is converted to the wired protocol (Block 535). If the protocol of the received user request was a wireless protocol (Block 530), the responsive query is converted from the common format of the self-service application to the wireless protocol (Block 540). The formatted responsive query is transmitted to the user (Block 545).

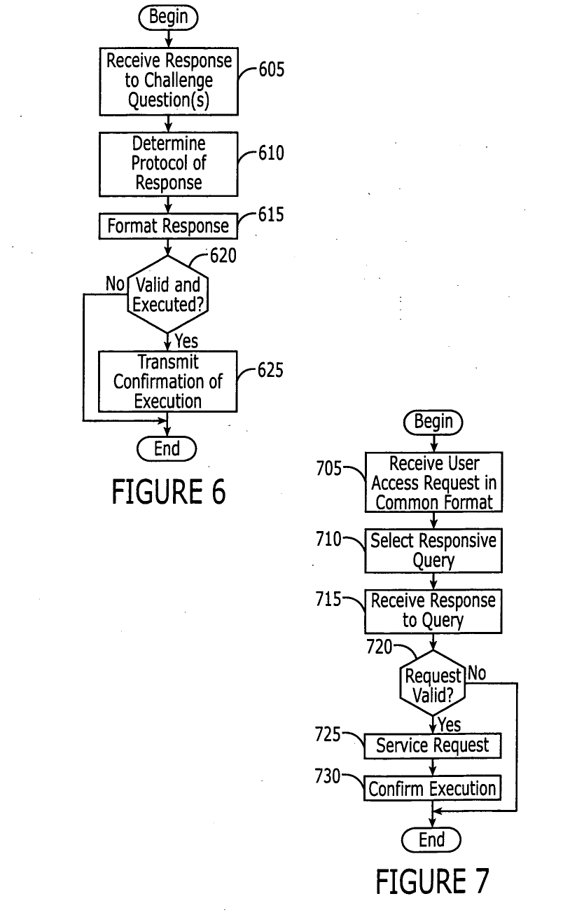

Operations related to further embodiments of the present invention will now be described with reference to the flow chart illustration of FIG. 6. The operations described with reference to FIG. 6 relate to communications between a user and the self-service application after a responsive query, such as challenge question(s), has been transmitted to the user, for example, at Block 545 of FIG. 5. A response to the challenge question(s) is received from the user at the server associated with the self-service application (Block 605). It is determined whether the received response to the challenge question(s) is a wireless or a wired protocol communication (Block 610). The received response to the challenge question(s) is then converted to the common data format of the self-service application for processing by the self-service application (Block 615). If the multi-protocol self-service application access system 130 receives confirmation from the self-service application that the user request has been validated and executed (Block 620), a confirmation of execution of the received self-service request is transmitted to a user (Block 625).

Operations that may be performed by the self-service application itself according to some embodiments of the present invention will now be described with reference to the flow chart illustration of FIG. 7. Operations begin at Block 705 when the self-service application receives a user access request in the common format from the multi-protocol self-service application access system 130. The appropriate responsive query is selected based on, for example, a user identifier contained in the user access request (Block 710). The response to the challenge question is received in the common format (Block 715). If the user access request is determined to be valid (Block 720), the user access request is serviced (Block 725). A confirmation of execution (servicing) of the user access request may then be provided to the multi-protocol self-service application access system 130 to be reformatted and transmitted to the user (Block 730).

As described above, embodiments of the present invention allow a remote user to access a self-service application from a wireless device by responding to text queries rather than by voice or dialtone inputs to an IVR system. A user may, as a result, be able to access the self-service application from either a local wired access point or a remote wireless access point using substantially the same basic method of typing into a keypad. As a result, embodiments of the present invention may enable remote and local employees to be serviced through a single application and interface. The costs and problems associated with integration between software and telephony using IVR may not be required to serve remote users. In addition, such an approach may be simpler to deploy and maintain than known IVR type systems for remote access to self-service applications. In particular, for embodiments utilizing a wireless protocol, such as WAP, no specialized software applications may be required by the end user as many currently available wireless terminal devices, such as mobile telephones, are WAP enabled.

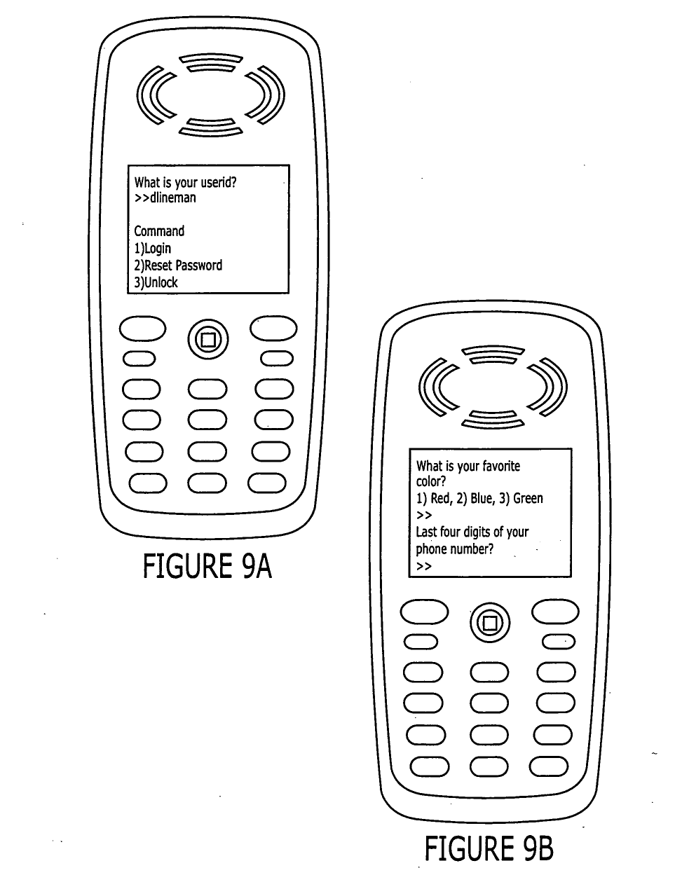

For example, FIG. 9A illustrates an exemplary mobile wireless terminal screen display for generating a user access request. FIG. 9B illustrates an exemplary screen display prompting a user for responses to query challenge questions used in validating a user access request.

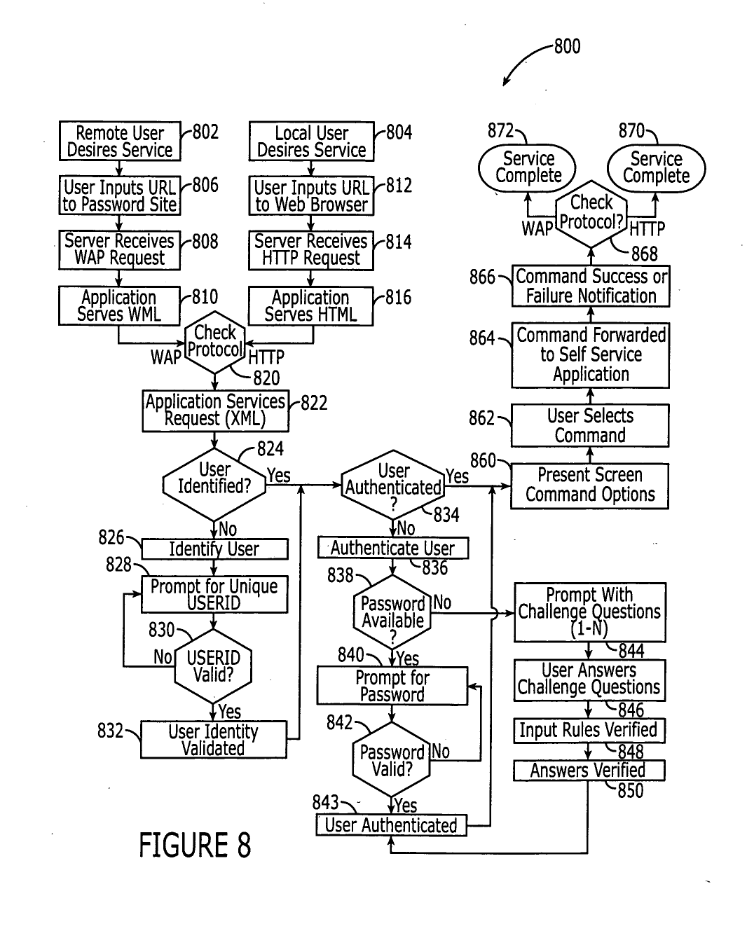

Operations for particular embodiments of the present invention where the self-service application is a network password maintenance application will now be described with reference to the flowchart illustration of FIG. 8. Operations related to converting a request to a common format of the system receiving the request will be described with reference to Blocks 802-822. As shown in FIG. 8, access for a remote user using a wireless protocol begins at Block 802 and access for a local user using a wired protocol begins at Block 804. The remote user inputs the universal resource locater (URL) through the keyboard or other input device of the mobile wireless terminal to identify the password site to the terminals WAP enabled interface application (Block 806). The server supporting the multi-protocol password maintenance access system receives the WAP request (Block 808) and the local application interface services the WAP request using the WML protocol (Block 810). Corresponding operations for the wired protocol using HTTP and HTML are illustrated at Blocks 812-816. In other words, for a remote user, for example, who has forgotten his or her network password, they may access the remote wireless internet from his or her mobile phone and choose a password reset link that was previously stored in the phonebook of the mobile phone. The password reset link on the local application (or through communications with the access service application) prompts the user for their personal identification number (PIN), which may then be entered by the user through the keypad on the mobile terminal.

The multi-protocol self-service access system receives the wireless or wired protocol formatted user access request and determines its protocol (Block 820). The access system then services and formats the user access request, for example, to XML format (Block 822).

Operations related to identifying a requesting user, i.e., determining if the requesting user is a valid user for the receiving self-service application, will now be described with reference to Blocks 824-832. If the requesting user has not previously been identified (Block 824), the user is identified (Block 826) including prompting the user for a unique user ID if such an identifier, such as a PIN, has not been provided with the user access request (Block 828). If the user ID is valid (Block 830), the user's identity is validated (Block 832). If not (Block 830), the user is again prompted for the user ID (Block 828).

After the user identity is validated at Block 832, authentication operations begin as will be described with reference to Blocks 834-850. If the requesting user has not previously been authenticated (Block 834), the user is authenticated (Block 836) including determining if a password is available and associated with the unique user identification (Block 838). If a password is available (Block 838), the user is prompted for the password (Block 840) and the password is verified (Block 842) before authenticating the user (Block 843).

If a password is not available (Block 838), the authenticated user is prompted with challenge questions maintained by either the self-service application access system or the self-service application and associated with the user ID (Block 844). The user answers the provided challenge question (Block 846) and input rules associated with the challenge questions verify whether the answers to the challenge questions are correct (Block 848). If the answers are verified at Block 850 the user is authenticated (Block 843) and operations continue at Block 860. If the user is not authenticated at Block 843, further opportunities for authentication may be provided by repeating the operations at Blocks 834-850.

Once the user has had their identification validated and been authenticated, the self-service access application may present associated screen command options (Block 860). For example, after asking multiple choice questions, such as “What's my favorite color?” and receiving responses in text form, such as number keys or selections from a list of available options, and a designated number of questions have been correctly answered (or designated percentage of questions has been correctly answered), the screen command options at Block 860 may be prompts for entering a new or temporary password that will be applied during a next login. In particular embodiments of the present invention, the self-service access application is configured to allow entry of passwords that are supported by the keypads of most WAP enabled mobile wireless devices.

It will be understood that between the operations at Block 860 of a presenting screen command options and the user selecting commands from the options (Block 862), the access system may provide for formatting between the common data format of the self-service application and the accessing device as needed. Alternatively, as shown in FIG. 8, the screen command options at Block 860 and receipt of user selection of commands at Block 862 may be implemented in the multi-protocol self-service access system itself, thus not requiring any protocol conversion to the common data format of the self-service application. In such embodiments, the command (such as updated password) can be formatted and forwarded to the self-service application where the command may be executed, for example, after being forwarded to and interpreted by the native system (such as Windows 2000) on which the self-service application resides (Block 864). Finally, the self-service access system and the self service application may be combined in a single system/application that may forward commands to a native system for execution. As such, all of the operations illustrated in FIG. 8 may be carried out by the self-service access system.

A success and/or failure notification may then be generated for communication to the user requesting service (Block 866). If the protocol of the received user access request was a wireless protocol (Block 868), the notification from Block 866 may be formatted using the WAP protocol to notify a remote user that service is complete (Block 872). Similarly, for a wired protocol user access request (Block 868), the notification of Block 866 may be formatted using the HTTP protocol to notify a local user of service completion (Block 870).

It will be understood that the block diagrams and flowchart illustrations of FIGS. 2 through 8 and combinations of blocks in the block diagrams and flowcharts may be implemented using discrete and integrated electronic circuits and software code. It will also be appreciated that blocks of the block diagrams and flowcharts of FIGS. 2 through 8 and combinations of blocks in the block diagrams and flowcharts may be implemented using components other than those illustrated in FIGS. 2 through 8, and that, in general, various blocks of the block diagrams and flowcharts and combinations of blocks in the block diagrams and flowcharts, may be implemented in special purpose hardware such as discrete analog and/or digital circuitry, combinations of integrated circuits or one or more application specific integrated circuits (ASICs).

Accordingly, blocks of the block diagrams and flowcharts of FIGS. 2 through 8 support electronic circuits and other means for performing the specified operations, as well as combinations of operations. It will be understood that the circuits and other means supported by each block and combinations of blocks can be implemented by special purpose hardware, software or firmware operating on special or general purpose data processors, or combinations thereof. It should also be noted that, in some alternative implementations, the operations noted in the flowcharts of FIGS. 4 through 8 may occur out of the order noted in the figures. For example, two blocks shown in succession may, in fact, be executed substantially concurrently, or the blocks may sometimes be executed in the reverse order.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A multi-protocol self-service application access method comprising:
receiving a user access request from a user at a server associated with the self-service application;
determining whether a protocol of the received request is a wireless or wired protocol;
formatting the received request to a common format for processing by the self-service application; and
selectively transmitting a responsive query from the self-service application to the user based on the wireless protocol when the received request is a wireless protocol request and based on the wired protocol when the received request is a wired protocol request based on whether the received request is determined to be a wireless or wired protocol.

2. The method of claim 1 wherein the self-service application comprises a network password and/or account privileges management application and wherein the responsive query comprises a challenge question to validate the user access request.

3. The method of claim 1 wherein transmitting a responsive query comprises:
formatting the responsive query based on the wireless protocol when the received request is a wireless protocol request and based on the wired protocol when the received request is a wired protocol request; and
transmitting the formatted responsive query.

4. The method of claim 3 wherein the wireless protocol comprises a wireless access protocol (WAP) and wherein the wired protocol comprises a Hypertext Transfer Protocol (HTTP).

5. The method of claim 4 wherein the wireless access protocol uses wireless mark-up language (WML) and wherein the wired protocol uses hypertext mark-up language (HTML).

6. The method of claim 3 wherein the common format comprises a data format of the self-service application and wherein formatting the responsive query includes receiving the responsive query from the self-service application in the data format of the self-service application.

7. The method of claim 6 wherein the formatted responsive query comprises a text query and the user access request comprises a text query.

8. The method of claim 7 wherein the user access request comprises a user identifier and wherein the responsive query comprises a challenge question selected based on the user identifier to validate the user access request.

9. The method of claim 8 wherein the method further comprises:
receiving a response to the challenge question from the user at the server associated with the self-service application;
determining whether the received response to the challenge question is a wireless or wired protocol request;
formatting the received response to the challenge question to the common format for processing by the self-service application; and
transmitting a confirmation of execution of the received self-service request to the user if the user access request is validated.

10. The method of claim 9 further comprising the following carried out by the self-service application:
receiving the user access request in the common format;
selecting the responsive query based on the user identifier;
receiving the received response to the challenge question in the common format;
determining if the user access request is valid based on the received response to the challenge question; and
servicing the user access request only if the user access request is valid.

11. The method of claim 9 wherein the self-service application comprises a network password and/or account privileges management application.

12. The method of claim 1 wherein the responsive query comprises a text query and the user access request comprises a text query.

13. A multi-protocol self-service application access system comprising:
a wireless protocol communication interface configured to receive a user access request from a user and transmit a responsive query to a user using a wireless protocol;
a wired protocol communication interface configured to receive a user access request from a user and transmit a responsive query to a user using a wired protocol; and
a conversion circuit configure to format the received user access requests to a common format for processing by the self-service application.

14. The system of claim 13 wherein the self-service application comprises a network password and/or account privileges management application and wherein the responsive query comprises a challenge question to validate the user access request.

15. The system of claim 13 wherein the conversion circuit is further configured to format the responsive query based on the wireless protocol when the received request is a wireless protocol request and based on the wired protocol when the received request is a wired protocol request.

16. The system of claim 15 wherein the wireless protocol comprises a wireless access protocol (WAP) and wherein the wired protocol comprises a Hypertext Transfer protocol (HTTP).

17. The system of claim 16 wherein the wireless access protocol uses wireless mark-up language (WML) and wherein the wired protocol uses hypertext mark-up language (HTML).

18. The system of claim 15 wherein the common format comprises a data format of the self-service application and wherein the conversion circuit is further configured to receive the responsive query from the self-service application in the data format of the self-service application.

19. The system of claim 18 wherein the formatted responsive query comprises a text query and the user access request comprises a text query.

20. The system of claim 18 wherein the user access request comprises a user identifier and wherein the responsive query comprises a challenge question selected based on the user identifier to validate the user access request.

21. The system of claim 20 wherein the conversion circuit is configured to format a received response to the challenge question in the wireless protocol or the wired protocol to the common format for processing by the self-service application and wherein the system further comprises a validation circuit that determines if the user access request is valid based on the formatted received response to the challenge question.

22. The system of claim 21 further comprising a service circuit that services the user access request only if the user access request is valid.

23. The system of claim 22 wherein the validation circuit and the service circuit comprise the self-service application.

24. The system of claim 23 wherein the self-service application comprises a network password and/or account privileges management application.

25. A computer program product for accessing a multi-protocol self-service application, the computer program product comprising:
a computer-readable storage medium having computer-readable program code embodied in said medium, said computer-readable program code comprising:
computer-readable program code that receives a user access request from a user at a server associated with the self-service application;
computer-readable program code that determines whether a protocol of the received request is a wireless or wired protocol;
computer-readable program code that formats the received request to a common format for processing by the self-service application; and
computer-readable program code that selectively transmits a responsive query from the self-service application to the user based on the wireless protocol when the received request is a wireless protocol request and based on the wired protocol when the received request is a wired protocol request based on whether the received request is determined to be a wireless or wired protocol.
